(19) United States
(12) Patent Application Publication
(10) Pub. No.: US 2008/0041078 A1
(43) Pub. Date: Feb. 21, 2008

(54) Method of controlling air conditioner in hybrid car

(76) Inventor: Yong-Kak Choi, Hwasung-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/606,196

(22) Filed: Nov. 28, 2006

(30) Foreign Application Priority Data
Aug. 17, 2006 (KR) 10-2006-0077704

(51) Int. Cl. F25D 17/04; B60H 1/32

(52) U.S. Cl. 62/186; 62/244

(57) ABSTRACT

A method of controlling an air conditioner in a hybrid car includes the steps of operating a blower at a low level after initial startup, controlling the blower for a predetermined time during idle-stop, maintaining a compressor duty to zero, and activating an air conditioner indicator during idle-stop. In the step of controlling a blower for a predetermined time during idle-stop, an operation mode may be automatically switched from a fresh mode to a recycle mode.

### CROSS-REFERENCE TO RELATED APPLICATIONS

The present application is based on, and claims priority from, Korean Application Serial Number 10-2006-0077704, filed on Aug. 17, 2006, the disclosure of which is hereby incorporated by reference herein in its entirety.

### FIELD OF THE INVENTION

The present invention relates to a method of controlling an air conditioner in a hybrid car that variably controls the air conditioner efficiently while the hybrid car is in an idle-stop mode.

### BACKGROUND OF THE INVENTION

Operation of a typical air conditioner in a hybrid vehicle is divided into switch operation and blower operation such that the air conditioner is turned on and off by the driver. When the air conditioner is switched on, the air conditioner is turned on and off according to a set temperature. Since an air conditioner compressor is driven, loss occurs in terms of fuel efficiency.

Air conditioners have recently been developed with improved fuel efficiency for hybrid cars. One such air conditioner is a variable control air conditioner, which segments an operating area of the compressor and varies the amount of torque for driving the compressor.

In case of the known on/off control of the compressor, a set amount of torque is needed anytime the air conditioner is turned on. However, in case of the variable control type of air conditioner, the amount of torque of the compressor is adjusted according to set target temperature.

Further, as the known on/off control of the compressor has been developed into the variable control of the compressor in the variable control air conditioner, a control range is widened. Therefore, as compared with the known on/off control, fuel efficiency is improved. That is, as the torque of the air conditioner is adjusted according to a driving state of an engine or driving conditions of the vehicle, the overall operation efficiency of the vehicle can be increased.

However, several problems are generated when a variable control air conditioner is applied to a hybrid car. For example, since hybrid cars have an idle-stop mode, the development of a variable control air conditioner logic that is suitable for hybrid cars is needed.

That is, if the car is in an idle-stop mode, the engine shuts off and thus the compressor cannot operate. Therefore, the blower is turned off and the operation of the air conditioner is stopped.

In order to overcome the above drawbacks, a cooling method that uses cool air remaining in an evaporator inside an air conditioner for a predetermined time by controlling the operation of a blower in a hybrid control unit (HCU) has been proposed.

However, on the basis of the air conditioner logic, the blower operates in “fresh” mode during idle-stop and sucks in external heat, which deteriorates the effect of air conditioning. In addition, since control logic of the compressor is developed according to a general vehicle without idle-stop, a control valve for controlling the operation of the variable control compressor is actuated even during idle-stop.

### SUMMARY OF THE INVENTION

A method of controlling an air conditioner in a hybrid car according to an exemplary embodiment of the present invention includes the steps of operating a blower at a low level after initial startup, controlling the blower for a predetermined time during idle-stop, maintaining a compressor duty at zero, and activating an air conditioner indicator during idle-stop. When the blower is controlled for a predetermined time during idle-stop, the operation mode is automatically switched from “fresh” mode to “recycle” mode.

### BRIEF DESCRIPTION OF THE DRAWINGS

For a better understanding of the nature and objects of the present invention, reference should be made to the following detailed description with the accompanying drawings, in which:

FIG. 1 illustrates a partial configuration of a hybrid car according to an embodiment of the present invention;

FIG. 2 is a diagram showing an air conditioner variable control entry section depending on dropping speed of the evaporator temperature;

FIG. 3 is a diagram showing an increase in evaporator temperature according to fresh/recycle mode during idle-stop;

FIG. 4 is a diagram showing an air conditioner control algorithm during idle-stop according to an embodiment of the present invention; and

FIG. 5 is a diagram showing a result of comparison of air conditioner performance.

### DETAILED DESCRIPTION OF THE PREFERRED EMBODIMENTS

Hereinafter, exemplary embodiments of the present invention will be described in detail with reference to the accompanying drawings.

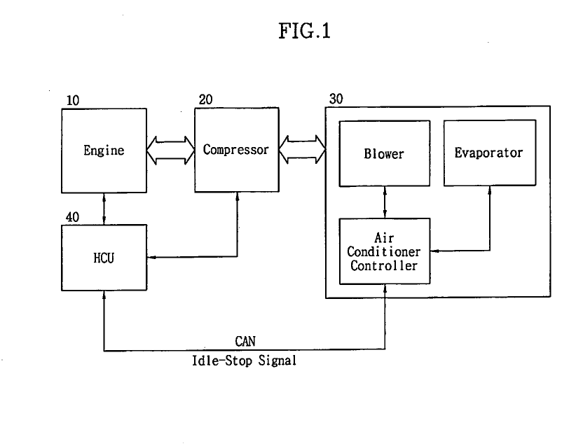

Referring to FIG. 1, a hybrid car includes an engine 10, a compressor 20, an air conditioner 30, and a hybrid control unit (HCU) 40. Air conditioner 30 has a blower, an evaporator, and an air conditioner controller. The air conditioner controller and the HCU 40 may each include a processor, memory, and associated hardware, software, and/or firmware as may be selected and programmed by a person of ordinary skill in the art based on the teachings herein.

Hybrid control unit 40 transmits an idle-stop signal to the air conditioner controller through a controller area network (CAN) communication of the hybrid car, such that the operation of the air conditioner is controlled during idle stop according to the inventive method, as will be described below.

The air conditioner 30 enters a variable control section when the target temperature and the actual temperature of the evaporator are equal to each other. The variable control is advantageous in terms of fuel efficiency. It is therefore important for the actual temperature of the evaporator to drop quickly in order for the air conditioner to enter the variable control section when the car departs after initial startup. In order for the actual temperature of the evaporator to quickly reach the target temperature, air flow of the blower is reduced when the air conditioner is running after initial startup. That is, the blower is operated at a low level at an initial stage. This operation needs to be appropriately controlled without influencing the indoor comfort.

Therefore, during idle-stop, in HCU 40, the blower is controlled for a predetermined time, during which time the passenger compartment is cooled by the existing cool air remaining in the evaporator.

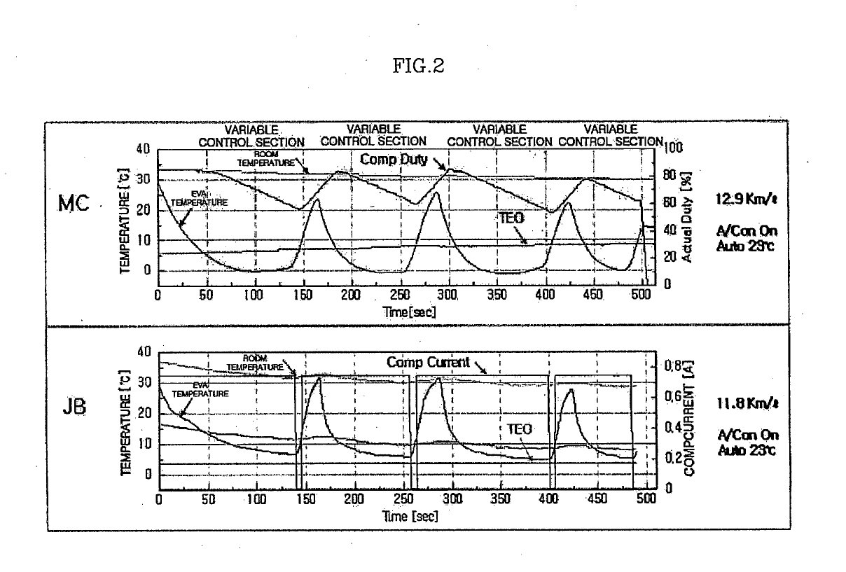

Referring to FIG. 2, which shows a comparison between air conditioner variable control entry sections depending on dropping speed of evaporator temperature, an air conditioner of a specific vehicle has a high dropping speed of the evaporator temperature after initial startup.

In addition, during idle-stop, an idle-stop entry signal, which is transmitted from HCU 40, is transmitted through the CAN communication. The air conditioner controller that receives the idle-stop entry signal switches the blower operating mode from “fresh” mode, in which fresh air from outside the vehicle is brought in, to “recycle” mode, in which air in the interior of the vehicle is recirculated, thereby preventing the actual temperature of the evaporator from rising. Therefore, a load on the compressor when the car starts after releasing the idle-stop is reduced, which further helps reduce fuel consumption.

Further, during idle-stop, by the idle-stop entry signal transmitted from HCU 40, the air conditioner controller maintains the compressor control duty to 0 to thereby minimize power consumed to maintain the operation of an expansion control valve (ECV) that has operated even during idle-stop. For example, it is possible to reduce power consumption to about 7 to 8 W.

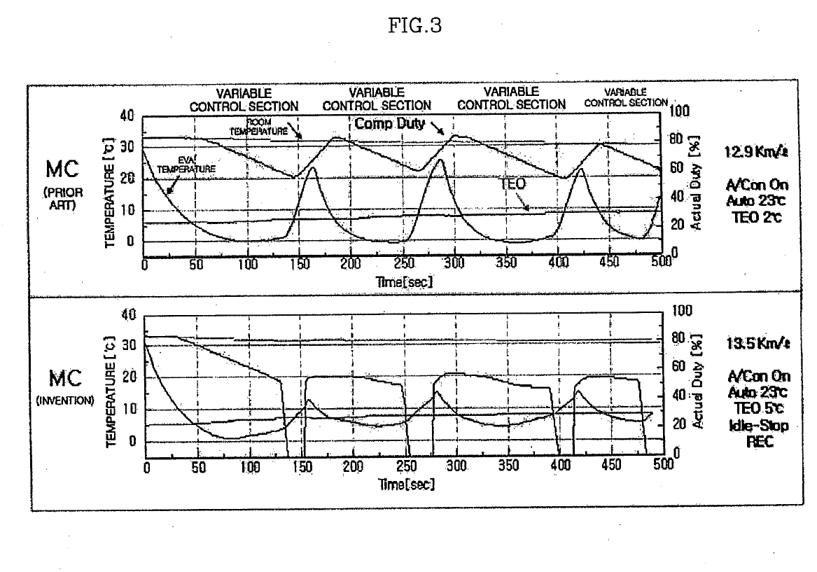

FIG. 3 shows a comparison between evaporator temperature in “fresh” mode and “recycle” mode during idle-stop. When cool air is emitted by operating the blower for a predetermined time during idle-stop, the rate of temperature increase in the evaporator when the “recycle” mode is maintained is smaller than that when the “fresh” mode is maintained. Therefore, even though the air conditioner enters the variable control section, the compressor needs a small amount of torque, which is advantageous for fuel savings.

Further, unnecessary operation of the ECV can be avoided by changing a compressor duty to 0 (zero) during idle-stop. After the idle-stop is released, the compressor duty is maintained for a predetermined time to thus improve fuel efficiency. For example, the compressor duty is maintained for one minute after releasing the idle-stop, thereby achieving fuel savings.

In addition, for the purpose of improving passenger convenience during idle-stop, it is possible to operate the blower normally even during idle-stop. An air conditioner indicator is activated during idle-stop to thereby provide preliminary display for the operation of the air conditioner after the idle-stop is released. For example, a user-manipulable air conditioner button may be provided with a light to indicate the operating state of the air conditioner. If the button is manipulated during idle stop, the light is illuminated as if the air conditioner were in a normal, non-idle stop mode, and once the vehicle is no longer in idle stop, an idle-stop release signal is transmitted to the air conditioner from HCU 40 through the CAN communication, and the air conditioner operates normally without additional user input.

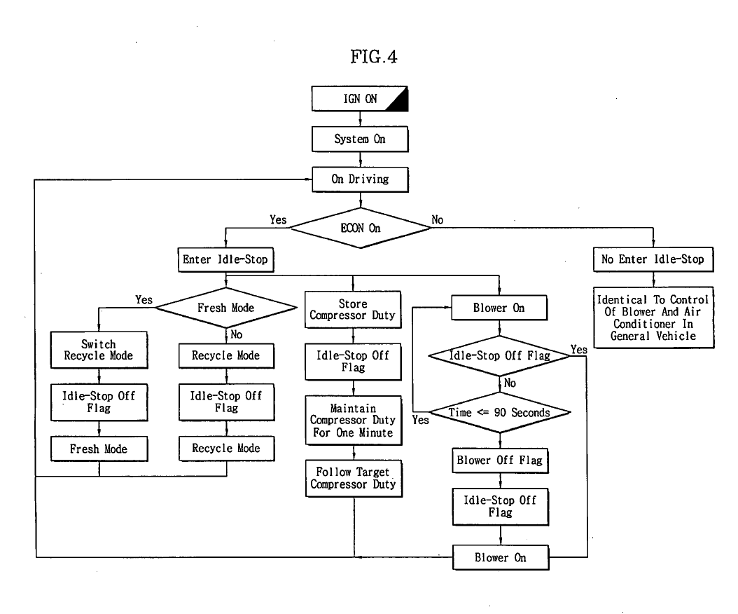

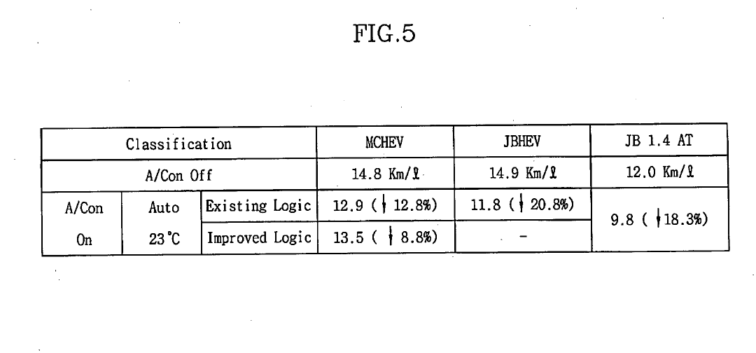

FIG. 4 shows a control algorithm that controls the operation of a variable control air conditioner during idle-stop. As a result of application of the control algorithm, as shown in FIG. 5, in vehicles to which the improved logic is applied as compared with vehicles to which the existing logic is applied, fuel efficiency is increased by about 4% in the case of an MCHEV (a first kind of vehicle developed by the assignee of the present invention), and fuel efficiency is increased by about 12% in the case of a JBHEV (a second kind of vehicle developed by the assignee of the present invention).

Further, as the blower operates for a predetermined time even during a state of idle-stop when the air conditioner operates, air cooling continues. The strength of the blower can be adjusted during the idle-stop state. As the air conditioner indicator is activated, the operation of the air conditioner after an idle-stop state is released can be prepared. Accordingly, user convenience is remarkably improved.

According to exemplary embodiment of the invention, the air conditioner is variably controlled efficiently during idle-stop of the hybrid car, such that fuel efficiency is improved, the cooling effect is maximized, and user convenience is remarkably improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling an air conditioner in a hybrid car, the method comprising the steps of:
operating a blower at a low level after initial startup;
controlling the blower for a predetermined time during idle-stop;
maintaining a compressor duty to zero; and
activating an air conditioner indicator during idle-stop.

2. The method as defined in claim 1, wherein in the step of controlling a blower for a predetermined time during idle-stop, an operation mode is automatically switched from a fresh mode to a recycle mode.
